(19) United States
(12) Patent Application Publication
(10) Pub. No.: US 2008/0294743 A1
(43) Pub. Date: Nov. 27, 2008

(54) INFORMATION PROCESSING DEVICE, COMPUTER READABLE RECORDING MEDIUM, AND INFORMATION PROCESSING METHOD

(75) Inventors: Noriji Kato, Kanagawa (JP); Takashi Isozaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 12/031,763

(22) Filed: Feb. 15, 2008

(30) Foreign Application Priority Data
May 24, 2007 (JP) 2007-138471

(51) Int. Cl. G06F 15/16; G06F 3/00

(52) U.S. Cl. 709/207; 715/745

(57) ABSTRACT

An information processing device includes: a first acquiring unit that acquires user operation information with respect to information in a server, based on a history stored in the server; a second acquiring unit that acquires a user operation history in a user terminal; a first creating unit that creates user behavior information with respect to the information in the server, based on the user operation information acquired by the first acquiring unit and the user operation history acquired by the second acquiring unit; a second creating unit that inquires of the user terminal for the priority level of sample information, and creates a probability table of priority levels of items included in the user behavior information; and an estimating unit that estimates the priority level of the information in the server for the user, based on the user behavior information created by the first creating unit and the priority level probability table created by the second creating unit.

### CROSS-REFERENCE TO RELATED APPLICATIONS

This application is based on and claims priority under 35 USC 119 from Japanese Patent Application No. 2007-138471 filed May 24, 2007.

### BACKGROUND

1. Technical Field

The present invention relates to an information processing device, a computer readable recording medium, and an information processing method.

2. Related Art

In recent years, computers (PCs) or special-purpose terminals connected via a network can share a large quantity of documents or information such as technical know-how. However, there have been problems that it is difficult for a user to promptly find desired information and it is also difficult to notice newly shared information. To counter those problems, there is a demand for a technique for automatically recommending documents desired by users. It is possible to estimate a document desired by a user, using a keyword designated by the user. However, when the interest of the user changes, the keyword needs to be changed, and the user needs to take a lot of trouble with the change of the setting.

### SUMMARY

According to an aspect of the invention, there is provided an information processing device that includes: a first acquiring unit that acquires user operation information with respect to information in a server, based on a history stored in the server; a second acquiring unit that acquires a user operation history in a user terminal; a first creating unit that creates user behavior information with respect to the information in the server, based on the user operation information acquired by the first acquiring unit and the user operation history acquired by the second acquiring unit; a second creating unit that inquires of the user terminal for the priority level of sample information, and creates a probability table of priority levels of items included in the user behavior information; and an estimating unit that estimates the priority level of the information in the server for the user, based on the user behavior information created by the first creating unit and the priority level probability table created by the second creating unit.

### BRIEF DESCRIPTION OF THE DRAWINGS

An exemplary embodiment of the present invention will be described in detail based on the following figures, wherein:

FIG. 1 is a block diagram showing the structure of an information processing system that includes an information processing device in accordance with an exemplary embodiment of the present invention;

FIG. 2 shows an example of the history information stored in the server log file;

FIG. 3 is a block diagram showing the hardware structure of the server;

FIG. 4 shows an example of the information extracted from the header of each mail by the mail information extracting unit;

FIG. 5 shows an example of the PC operation information;

FIG. 6 shows an example of the behavior information;

FIG. 7 shows the structure of a Bayesian network;

FIG. 8A shows an example of a probability table of the viewing time node of a user A;

FIG. 8B shows an example of a probability table of the responding node of the user A;

FIG. 8C shows an example of a probability table of the deleting node of the user A;

FIG. 8D shows an example of a probability table of the viewing order node of the user A;

FIG. 8E shows an example of prior probabilities;

FIG. 9A shows an example of a probability table of the viewing time node of a user B;

FIG. 9B shows an example of a probability table of the responding node of the user B;

FIG. 9C shows an example of a probability table of the deleting node of the user B;

FIG. 9D shows an example of a probability table of the viewing order node of the user B;

FIG. 9E shows an example of prior probabilities;

FIG. 10 shows an example of the sender information; and

FIG. 11 is a flowchart showing an operation to be performed by the server.

### DETAILED DESCRIPTION

The following is a description of an exemplary embodiment of the present invention, with reference to the accompanying drawings.

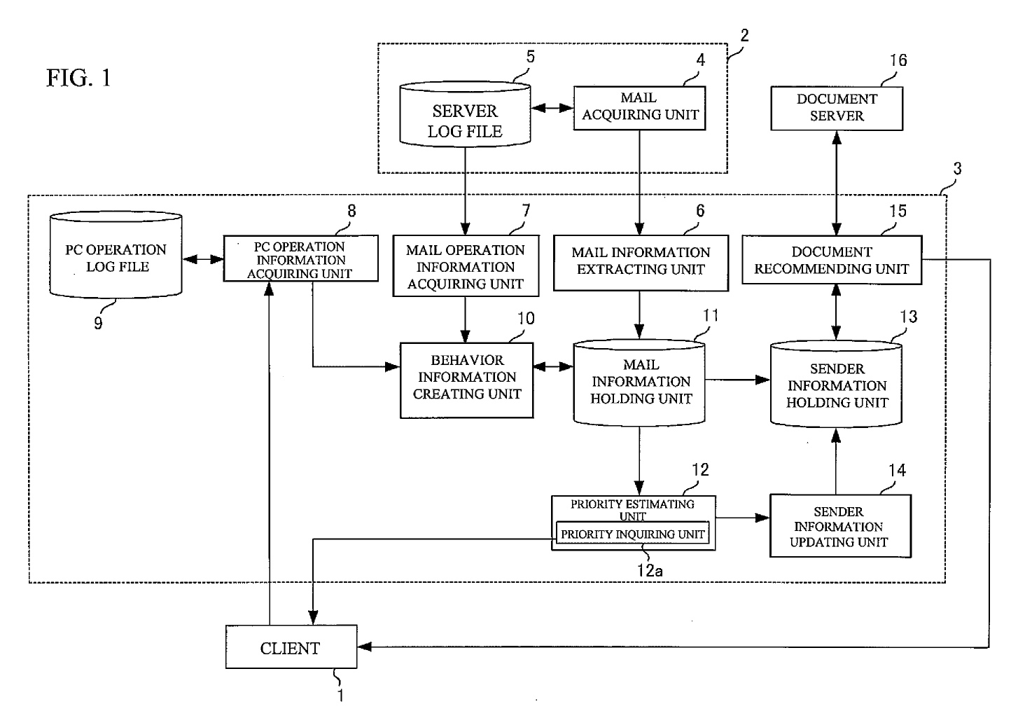

FIG. 1 is a block diagram showing the structure of an information processing system that includes an information processing device in accordance with an exemplary embodiment of the present invention.

The system shown in FIG. 1 includes a client 1, a mail server 2, a server 3 (the information processing device), and a document server 16. The document server 16 stores documents.

The mail server 2 includes a mail acquiring unit 4 that obtains mail in response to a request from an external terminal such as the client 1, and a server log file 5 that stores the mail acquired by the mail acquiring unit 4 and history information indicating the history of accesses of external terminals such as the client 1 to the mail server 2. In the following description, the client 1 is used as a typical external terminal, but clients are not limited to the client 1.

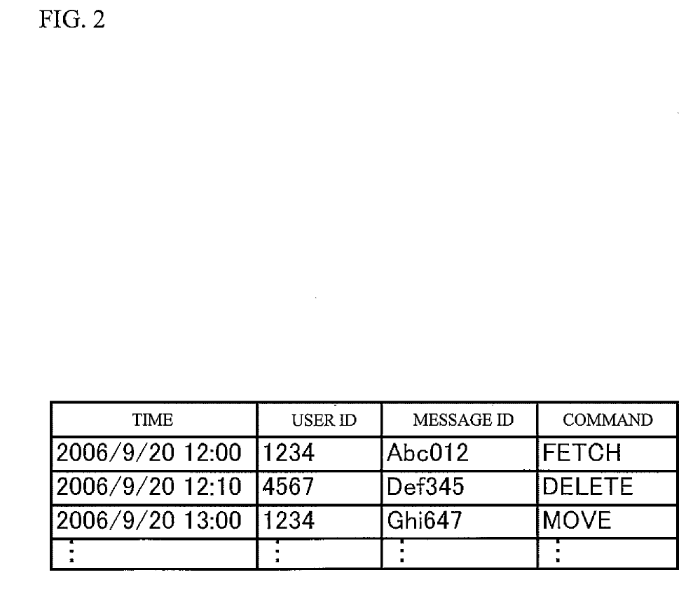

FIG. 2 shows an example of the history information to be stored in the server log file 5. The history information includes the access time at which the client 1 accesses the mail server 2, the user ID of the client 1 accessing the mail server 2, the message ID of the mail, and the command concerning the mail at the time of the access. The command may be a FETCH command for the client 1 to obtain the message of the mail from the mail server 2, a DELETE command to delete the message of the mail from the mail server 2, a MOVE command to move the message of the mail to a designated folder, or a FLAG command to add a flag indicating that a response has been made to the message of the mail.

The server 3 shown in FIG. 1 includes a mail information extracting unit 6, a mail operation information acquiring unit 7 (a first acquiring unit), a PC operation information acquiring unit 8 (a second acquiring unit), a PC operation log file 9, a behavior information creating unit 10 (a first creating unit), a mail information holding unit 11, a priority estimating unit 12 (a second creating unit, an estimating unit), a sender information holding unit 13, a sender information updating unit 14, and a document recommending unit 15.

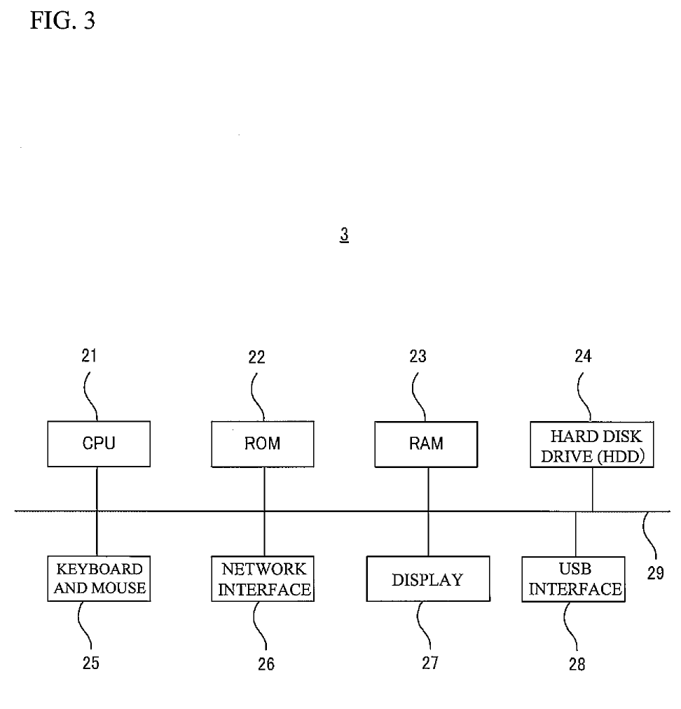

FIG. 3 is a block diagram showing the hardware structure of the server 3.

The server 3 includes a CPU 21 that controls the entire device, a ROM 22 that stores a control program, a RAM 23 that functions as a working area, a hard disk drive (HDD) 24 that stores various kinds of information and programs, a mouse and keyboard 25, a network interface 26 that establishes a connection to another computer, a display 27 that is formed with a liquid crystal monitor or CRT, and a USB (universal serial bus) interface 28 that establishes a connection with an external device. The CPU 21 is connected to the ROM 22, the RAM 23, the hard disk drive (HDD) 24, the mouse and keyboard 25, the network interface 26, the display 27, and the USB interface 28, via a system bus 29.

The mail information extracting unit 6, the mail operation information acquiring unit 7, the PC operation information acquiring unit 8, the behavior information creating unit 10, the priority estimating unit 12, the sender information updating unit 14, and the document recommending unit 15 shown in FIG. 1 are equivalent to the CPU 21 that performs various operations in accordance with the control program. The PC operation log file 9, the mail information holding unit 11, and the sender information holding unit 13 are equivalent to the hard disk drive (HDD) 24. Each of the hardware structures of the client 1, the mail server 2, and the document server 16 is the same as the hardware structure of the server 3, and therefore, explanation of them is omitted here.

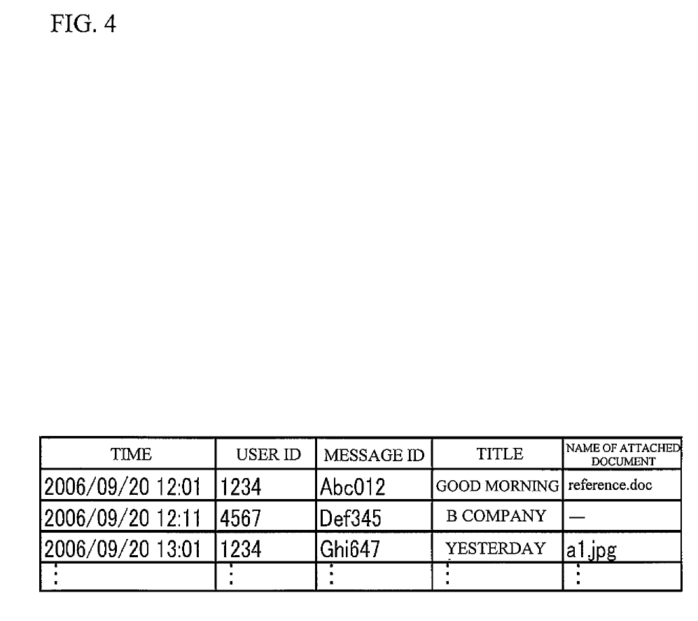

The mail information extracting unit 6 acquires the mail stored in the server log file 5 through the mail acquiring unit 4. The mail information extracting unit 6 extracts the information of the message, such as the message ID, the title, and the name of the attached document, from the header of the mail. The mail information extracting unit 6 then stores the extracted information in the mail information holding unit 11. FIG. 4 shows an example of the information extracted from the header of a mail by the mail information extracting unit 6. The extraction of information from a mail header is performed when a new mail is arrived at the user, for example.

Upon receipt of a request from the behavior information creating unit 10, the mail operation information acquiring unit 7 acquires, from the server log file 5, the information (the contents of operations, the operation time, and the likes) related to the operation of the user with respect to mails in accordance with the request. The mail operation information acquiring unit 7 then supplies the information to the behavior information creating unit 10.

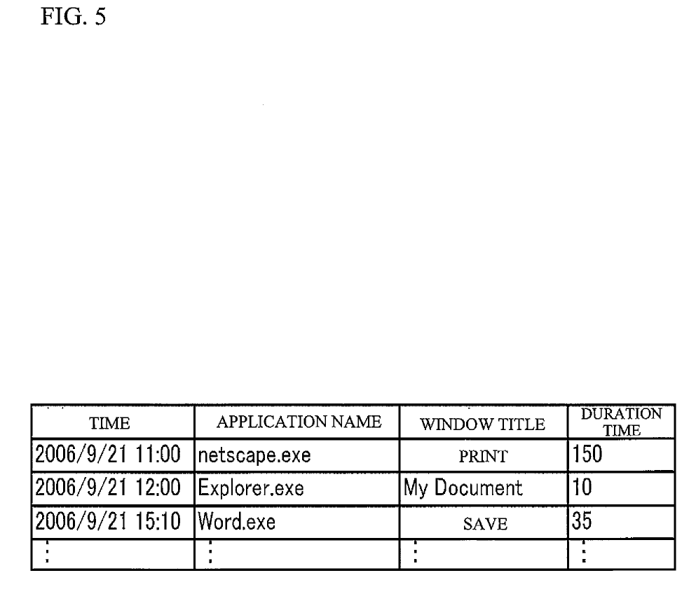

The PC operation information acquiring unit 8 acquires PC operation information indicating various PC operations performed by the user, and stores the PC operation information in the PC operation log file 9. More specifically, the PC operation information acquiring unit 8 acquires a process that is active in the client 1, and then determines the name of the application that is being used by the user. The PC operation information acquiring unit 8 then obtains the title of the window associated with the process. Every time an active process is changed to another process, the PC operation information acquiring unit 8 stores the PC operation information in the format shown in FIG. 5 into the PC operation log file 9. The PC operation information includes the name of the application, the title of the window, the time at which the processes are switched, and the duration time.

Also, upon receipt of a request from the behavior information creating unit 10, the PC operation information acquiring unit 8 searches the PC operation information stored in the PC operation log file 9, with the title of the window containing a certain character string being the search key. The PC operation information acquiring unit 8 then returns the search results to the behavior information creating unit 10.

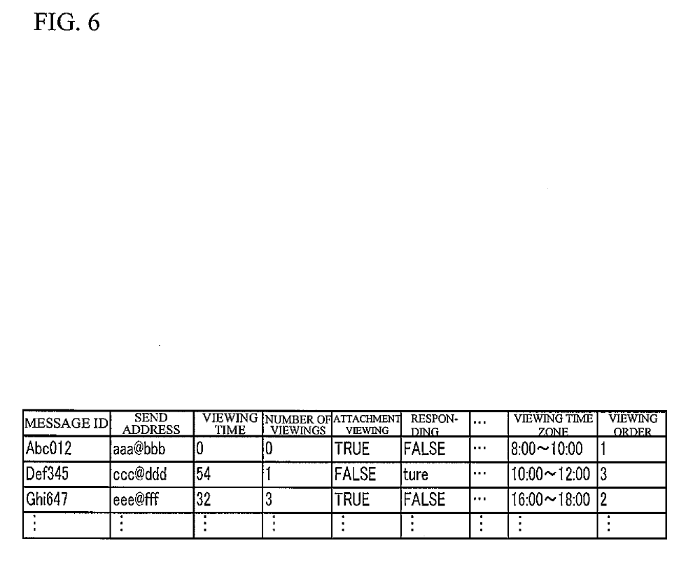

Based on the information supplied from the mail operation information acquiring unit 7 and the PC operation information acquiring unit 8, the behavior information creating unit 10 creates behavior information for each mail, and stores the behavior information having the format shown in FIG. 6 into the mail information holding unit 11. The behavior information includes data concerning “message ID”, “sender address”, “viewing time”, “number of viewings”, “attachment viewing”, “responding”, “forwarding”, “deleting”, “deleting time”, “printing”, “saving”, “place of saving”, “viewing order”, and “viewing time zone”. The “viewing time”, “number of viewings”, and “attachment viewing” fall into the category of viewing. The “responding” and “forwarding” fall into the category of communication. The “deleting”, “deleting time”, “printing”, “saving”, and “place of saving” fall into the category of sorting. The “viewing order” and “viewing time zone” fall into the category of priority levels.

In the following, examples of methods for creating the data concerning the items included in the behavior information are described.

(1) Viewing Time

The behavior information creating unit 10 obtains time T1 at which a FETCH command is executed with respect to a message ID, from the mail operation information acquiring unit 7. After the time T1, the behavior information creating unit 10 obtains time T2 at which the next FETCH command is executed, from the mail operation information acquiring unit 7. The behavior information creating unit 10 obtains time T3 at which the mail application stops being active for the first time after the time T1, from the PC operation information acquiring unit 8. After that, the behavior information creating unit 10 subtracts the time T1 from the time T2 or T3, whichever is the earlier, so as to obtain the “viewing time”.

(2) Number of Viewings

The behavior information creating unit 10 obtains the number of times a FETCH command is issued with respect to the above message ID, from the mail operation information acquiring unit 7. The obtained number of times is set as the “number of viewings”.

(3) Attachment Viewing

The behavior information creating unit 10 obtains the name of the attached document related to the above message ID, from the mail information holding unit 11. The behavior information creating unit 10 inquires of the PC operation information acquiring unit 8 whether the PC operation information including the name of the attached document as a title exists in the PC operation log file 9, and whether the PC operation information including the character string of “print” immediately after the PC operation information exists in the PC operation log file 9. If the behavior information creating unit 10 obtains, from the PC operation information acquiring unit 8, the information indicating that the PC operation information satisfying the above conditions exists in the PC operation log file 9, the behavior information creating unit 10 determines that the attached document has been viewed. If the behavior information creating unit 10 cannot obtain, from the PC operation information acquiring unit 8, the information indicating that the PC operation information satisfying the above conditions exists in the PC operation log file 9, the behavior information creating unit 10 determines that the attached document has not been viewed. If the behavior information creating unit 10 determines that the attached document has been viewed, “true” is put to the item of “attachment viewing” included in the behavior information. If the behavior information creating unit 10 determines that the attached document has not been viewed, “false” is put to the item of “attachment viewing” included in the behavior information.

(4) Responding, Deleting

The behavior information creating unit 10 inquires of the mail operation information acquiring unit 7 whether there is history information indicating that an Answered flag or a Deleted flag has been added to the above message ID. If the behavior information creating unit 10 obtains a reply indicating that the history information exists from the mail operation information acquiring unit 7, the behavior information creating unit 10 determines that there has been a response to the message or the message has been deleted. If the behavior information creating unit 10 cannot obtain a reply indicating that the history information exists from the mail operation information acquiring unit 7, the behavior information creating unit 10 determines that there has not been a response to the message or the message has not been deleted. If the behavior information creating unit 10 determines that there has been a response to the message or the message has been deleted, “true” is put to the item of “responding” or “deleting” included in the behavior information. If the behavior information creating unit 10 determines that there has not been a response to the message or the message has not been deleted, “false” is put to the item of “responding” or “deleting” included in the behavior information.

(5) Deleting Time

The behavior information creating unit 10 obtains the time T1 at which a FETCH command is executed with respect to the above message ID, from the mail operation information acquiring unit 7. The behavior information creating unit 10 also obtains time T4 at which a Deleted flag is added to the above message ID, from the mail operation information acquiring unit 7. The behavior information creating unit 10 subtracts the time T1 from the time T4, so as to obtain the time required for deleting the message.

(6) Saving

The behavior information creating unit 10 obtains the title related to the above message ID, from the mail information holding unit 11. The behavior information creating unit 10 inquires of the PC operation information acquiring unit 8 whether the PC operation information including the title of the message exists in the PC operation log file 9, and whether the PC operation information including the character string of “saving” exists immediately after the PC operation information in the PC operation log file 9. If the behavior information creating unit 10 obtains, from the PC operation information acquiring unit 8, the information indicating that the PC operation information satisfying the above conditions exists in the PC operation log file 9, the behavior information creating unit 10 determines that there has been a message saving operation. If the behavior information creating unit 10 cannot obtain, from the PC operation information acquiring unit 8, the information indicating that the PC operation information satisfying the above conditions exists in the PC operation log file 9, the behavior information creating unit 10 determines that there has not been a message saving operation. If the behavior information creating unit 10 determines that there has been a message saving operation, “true” is put to the item of “saving” included in the behavior information. If the behavior information creating unit 10 determines that there has not been a message saving operation, “false” is put to the item of “saving” included in the behavior information.

(7) Viewing Time Zone

The behavior information creating unit 10 obtains the time T1 at which a FETCH command is executed with respect to the above message ID, from the mail operation information acquiring unit 7. The behavior information creating unit 10 then converts the time T1 into a predetermined viewing time zone of a 2-hour's duration, for example. In this manner, the behavior information creating unit 10 obtains the “viewing time zone”.

(8) Viewing Order

The behavior information creating unit 10 obtains the time T1 at which a FETCH command is executed with respect to the above message ID, from the mail operation information acquiring unit 7. The behavior information creating unit 10 also obtains the PC operation information indicating the period during which the mail application stops being active, including the time T1, from the PC operation log file 9 via the PC operation information acquiring unit 8. After that, the behavior information creating unit 10 obtains, from the mail operation information acquiring unit 7, all the times at which a FETCH command is executed during the period. The behavior information creating unit 10 then determines where the time T1 is in the chronological order among all the obtained times. In this manner, the “viewing order” is determined.

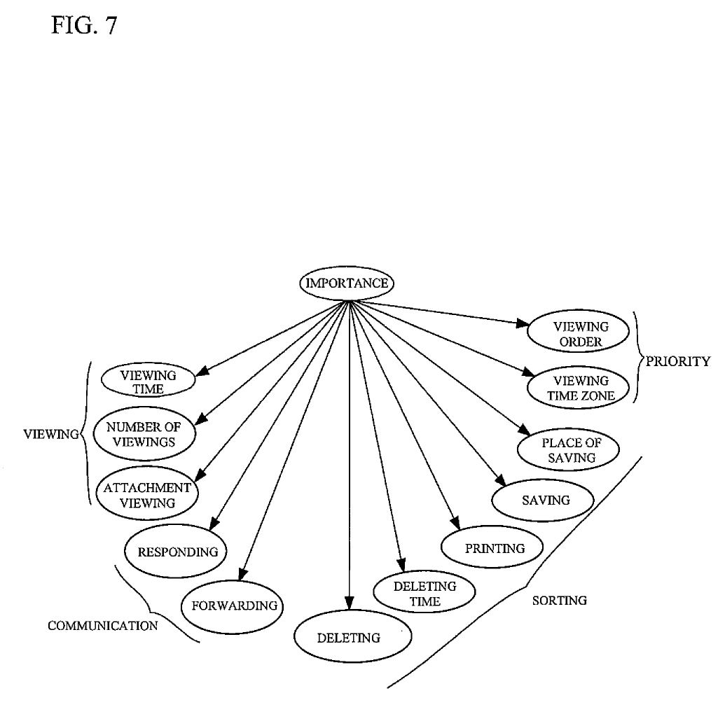

The priority estimating unit 12 shown in FIG. 1 may be formed with the Bayesian network shown in FIG. 7, for example. Based on the behavior information shown in FIG. 6, the priority estimating unit 12 estimates the priority level of each mail for each user. A priority level is a probability that the nodes (the factors such as the “viewing time”, “number of viewings”, and “attachment viewing” shown in FIG. 7) indicating the importance of the subject mail are important factors.

In the Bayesian network shown in FIG. 7, the nodes of “viewing time”, “number of viewings”, and “attachment viewing” fall into the category of viewing. The nodes of “responding” and “forwarding” fall into the category of communication. The nodes of “deleting”, “deleting time”, “printing”, “saving”, and “place of saving” fall into the category of sorting. The nodes of “viewing order” and “viewing time zone” fall into the category of priority levels. It should be noted here that the nodes and categories shown in FIG. 7 are merely examples, and the present invention is not limited to them. Also, those nodes are equivalent to the respective items included in the above behavior information.

In general, the methods for processing mails greatly vary among users. Therefore, a probability table of a Bayesian network should be acquired through learning. The priority estimating unit 12 includes a priority inquiring unit 12a (the second creating unit) that inquires of the user of the client 1 whether the mail being read by the user is important. The priority estimating unit 12 learns a probability table (or creates a probability table), using the results of the inquiries made by the priority inquiring unit 12a as the reference data. For example, the learning is performed for the first 100 mails (sample information) of each user. A probability table is created for each node or for each item included in the behavior information.

Next, a specific example of the priority estimating operation to be performed by the priority estimating unit 12 is described.

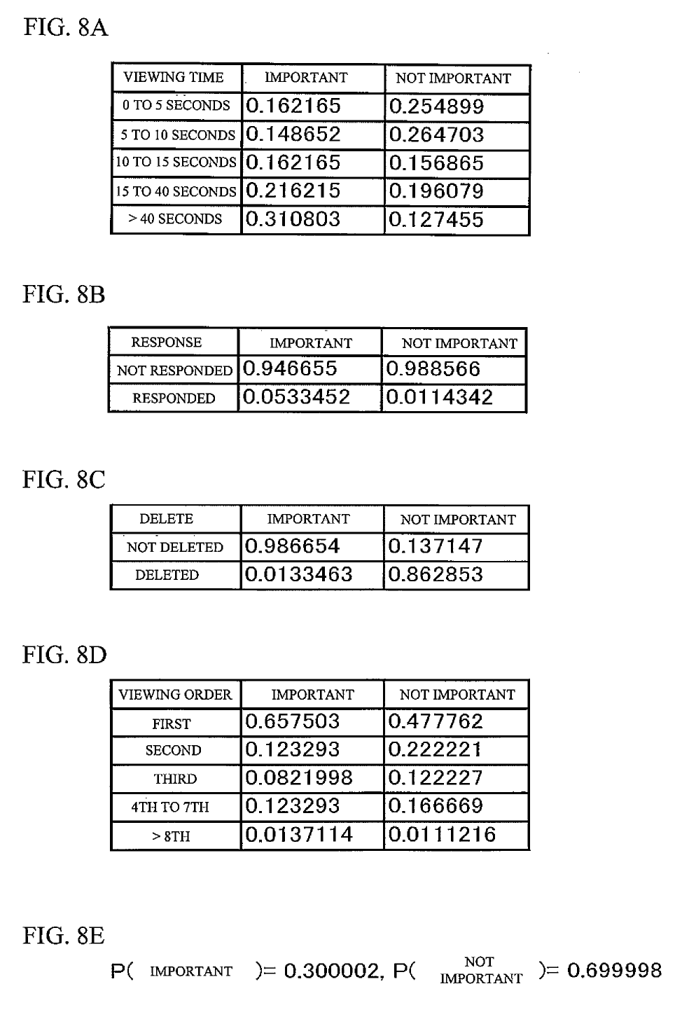

FIG. 8A shows an example of the probability table with respect to the viewing time node of a user A, which is created based on the results of inquiries made by the priority inquiring unit 12a. FIG. 8B shows an example of the probability table with respect to the responding node of the user A, which is created based on the results of inquiries made by the priority inquiring unit 12a. FIG. 8C shows an example of the probability table with respect to the deleting node of the user A, which is created based on the results of inquiries made by the priority inquiring unit 12a. FIG. 8D shows an example of the probability table with respect to the viewing order node of the user A, which is created based on the results of inquiries made by the priority inquiring unit 12a. FIG. 8E shows prior probabilities that are determined based on the results of inquiries made by the priority inquiring unit 12a. The prior probabilities indicate the proportion of important mails and the proportion of unimportant mails among all the mails to be learned.

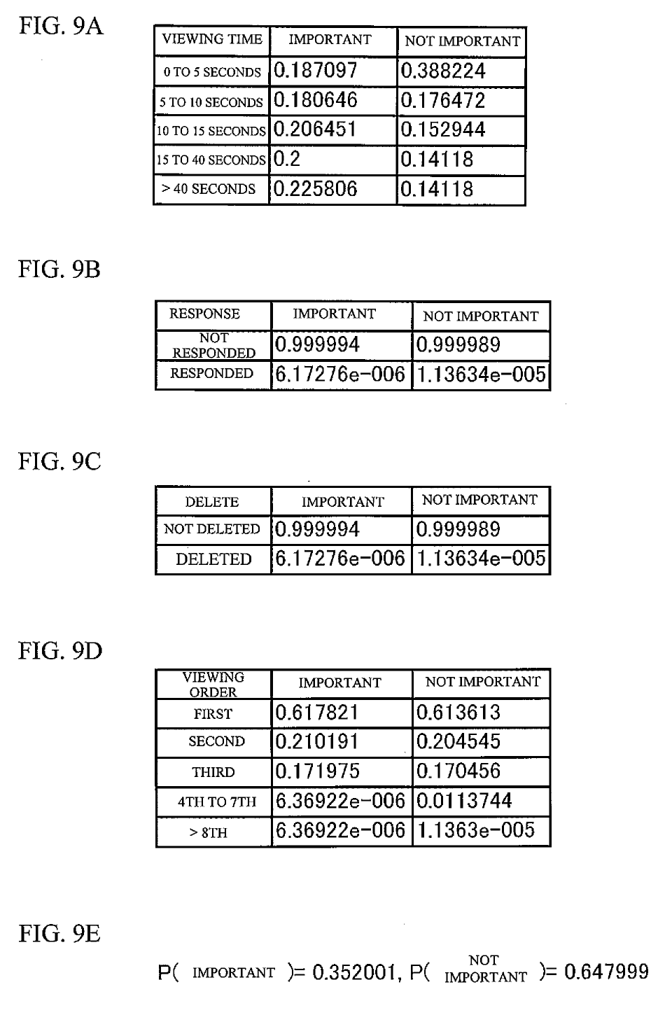

FIG. 9A shows an example of the probability table with respect to the viewing time node of a user B, which is created based on the results of inquiries made by the priority inquiring unit 12a. FIG. 9B shows an example of the probability table with respect to the responding node of the user B, which is created based on the results of inquiries made by the priority inquiring unit 12a. FIG. 9C shows an example of the probability table with respect to the deleting node of the user B, which is created based on the results of inquiries made by the priority inquiring unit 12a. FIG. 9D shows an example of the probability table with respect to the viewing order node of the user B, which is created based on the results of inquiries made by the priority inquiring unit 12a. FIG. 9E shows prior probabilities that are determined based on the results of inquiries made by the priority inquiring unit 12a.

The priority estimating unit 12 estimates the importance of each mail by assigning the values of the probability tables of FIGS. 8A through 8D into the following equation (1):

$$P ( IMP \vert {F}_{1} , {F}_{2} , … , {F}_{n} ) = \frac{P ( {F}_{1} \vert IMP ) \cdot P ( {F}_{2} \vert IMP ) … P ( {F}_{n} \vert IMP ) \cdot P ( IMP )}{P ( {F}_{1} , {F}_{2} , … , {F}_{n} )} \qquad ( 1 )$$

In the above equation, “IMP” represents the state of the priority node, which is “important” or “not important”. “Fi” represents the state of the node of the ith factor. For example, the priority level of a mail that satisfies the conditions “viewing time: 20 seconds”, “not to be responded”, “not to be deleted”, and “viewed first” is calculated as follows:

$$P ( important \vert {F}_{1} , {F}_{2} , … , {F}_{n} ) = \frac{0.216215 \times 0.946655 \times 0.657503 \times 0.300002}{P ( {F}_{1} , {F}_{2} , … , {F}_{n} )}$$

$$P ( not important \vert {F}_{1} , {F}_{2} , … , {F}_{n} ) = \frac{0.196079 \times 0.988566 \times 0.137147 \times 0.477762 \times 0.6999998}{P ( {F}_{1} , {F}_{2} , … , {F}_{n} )}$$

$$If the probabilities are standardized , \\ P ( important \vert {F}_{1} , {F}_{2} , … , {F}_{n} ) = \frac{0.0398349}{0.0088906081} = 0.817537$$

$$P ( not important \vert {F}_{1} , {F}_{2} , … , {F}_{n} ) = 1 - 0.817537 = 0.182463$$

Likewise, the priority level of a mail that satisfies the conditions “viewing time: 20 seconds”, “not to be responded”, “not to be deleted”, and “viewed first” is calculated to obtain a priority level P of 0.4365614 (important) and a priority level P of 0.5634386 (not important).

In the above manner, the priority estimating unit 12 estimates the priority level of each mail of each user, based on a probability table and the behavior information shown in FIG. 6.

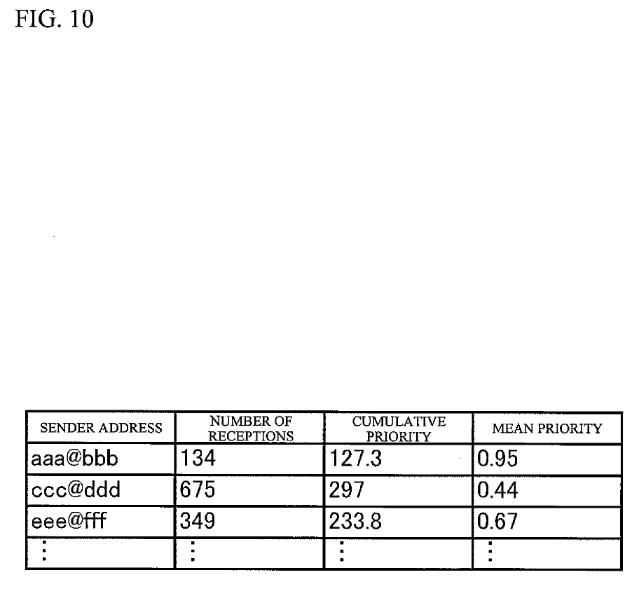

The sender information holding unit 13 shown in FIG. 1 holds the sender information indicating the mail address of each sender, the number of mail receptions, and the relationship between the cumulative priority level and the mean priority level. FIG. 10 shows an example of the sender information.

The sender information updating unit 14 obtains the priority level of the mail from the priority estimating unit 12, and also obtains the address of the sender of the mail from the mail information holding unit 11 via the priority estimating unit 12. Based on the obtained priority level of the mail and the obtained address of the sender, the sender information updating unit 14 updates the sender information in the sender information holding unit 13. More specifically, the sender information updating unit 14 adds “1” to the number of receptions in the sender information associated with the same sender as the mail sender obtained from the mail information holding unit 11. The sender information updating unit 14 also adds the mail priority level associated with the mail sender to the cumulative priority level. Dividing the number of receptions into the value of the cumulative priority level, the sender information updating unit 14 calculates the mean priority level. In this manner, the sender information updating unit 14 updates the sender information in the sender information holding unit 13.

Based on the sender information in the sender information holding unit 13, the document recommending unit 15 presents a document registered in the document server 16 to the user of the client 1. For example, the document recommending unit 15 always monitors the documents in the document server 16. If there is an added document or an updated document in the document server 16, the document recommending unit 15 obtains the information about the creator of the added or updated document from the document server 16. If the sender information holding unit 13 includes the sender information equivalent to the information about the creator of the document, the document recommending unit 15 obtains the mean priority level of the corresponding sender. If the obtained mean priority level indicates a value equal to or higher than a predetermined threshold value (0.7, for example), the document recommending unit 15 presents the added or updated document to the user of the client 1.

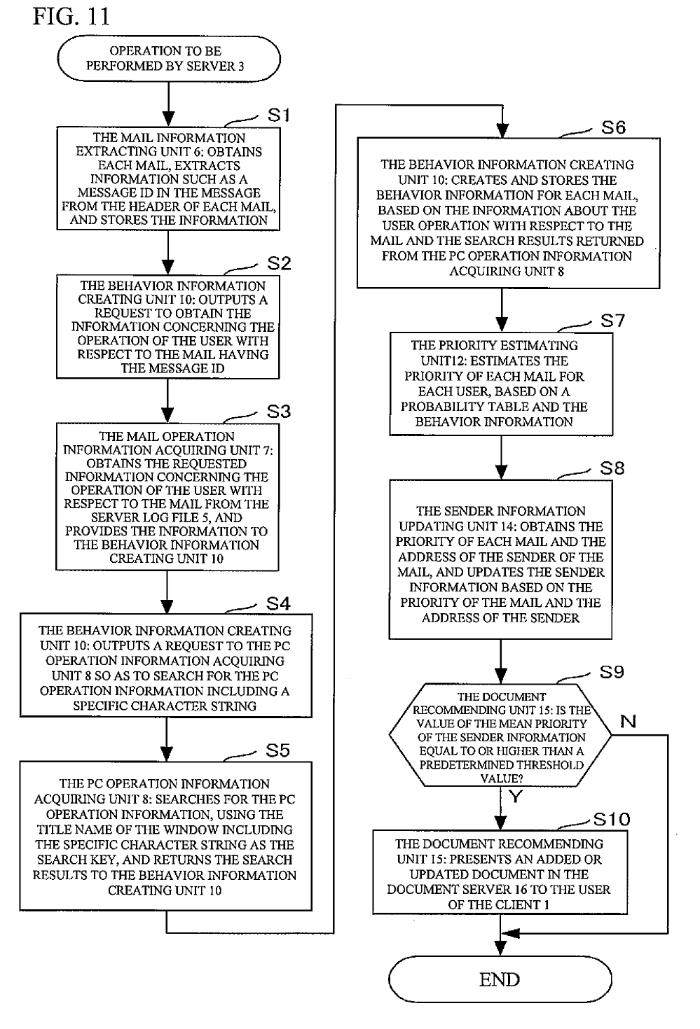

FIG. 11 is a flowchart showing an operation to be performed by the server 3.

First, the mail information extracting unit 6 obtains each mail stored in the server log file 5 via the mail acquiring unit 4. The mail information extracting unit 6 then extracts the information in the message such as the message ID, the title, and the name of the attached document from the header of the mail, and stores the extracted information in the mail information holding unit 11 (step S1).

The behavior information creating unit 10 outputs a request to the mail operation information acquiring unit 7, so as to obtain the information about the operation performed by the user for the mail having the message ID stored in the mail information holding unit 11 (step S2). Upon receipt of the request from the behavior information creating unit 10, the mail operation information acquiring unit 7 obtains the requested information about the operation of the user for the mail (the contents of the operation, the time of the operation, and the likes) from the server log file 5, and provides the information to the behavior information creating unit 10 (step S3).

The behavior information creating unit 10 then outputs a request to the PC operation information acquiring unit 8, so as to search for the PC operation information including a specific character string such as “printing or “saving” (step S4). Upon receipt of the request from the behavior information creating unit 10, the PC operation information acquiring unit 8 searches the PC operation information stored in the PC operation log file 9, using the title name of the window having the specific character string as the search key, and returns the search results to the behavior information creating unit 10 (step S5). The search results include the time, the application name, the title of the window, the duration time, and the likes.

Based on the information about the operation of the user for the mail provided in step S3 and the search results returned from the PC operation information acquiring unit 8 in step S5, the behavior information creating unit 10 creates the behavior information for each mail, and stores the behavior information in the mail information holding unit 11 (step S6).

Based on the behavior information and a probability table that is obtained through advance learning, the priority estimating unit 12 estimates the priority level of each mail for each user (step S7).

The sender information updating unit 14 then obtains the priority level of each mail from the priority estimating unit 12, and also obtains the address of the sender of each corresponding mail from the mail information holding unit 11 via the priority estimating unit 12. Based on the obtained priority level of the mail and the address of the sender, the sender information updating unit 14 updates the sender information in the sender information holding unit 13 (step S8).

The document recommending unit 15 determines whether the value of the mean priority level of the sender information is equal to or higher than a predetermined threshold value (step S9). If the value of the mean priority level is smaller than the predetermined threshold value, this operation comes to an end. If the value of the mean priority level is equal to or higher than the predetermined threshold value, the document recommending unit 15 presents the added or updated document in the document server 16 to the user of the client 1 (step S10), and then ends this operation.

As described above, in accordance with this exemplary embodiment, the mail operation information acquiring unit 7 obtains the user operation information with respect to each mail from the history stored in the mail server 2. The PC operation information acquiring unit 8 obtains the user operation history in the client 1. Based on the user operation information obtained by the mail operation information acquiring unit 7 and the user operation history obtained by the PC operation information acquiring unit 8, the behavior information creating unit 10 creates the behavior information about the user with respect to each mail. The priority inquiring unit 12a inquires of the client 1 for the priority levels of the first 100 mails (sample information), and the priority estimating unit 12 creates a probability table showing the priority levels in accordance with each item included in the behavior information about the user. Based on the behavior information about the user and the probability table of the priority levels, the priority estimating unit 12 estimates the priority level of each mail for the user. In this manner, based on the behavior information about the user and the probability table of the priority levels, the server 3 can estimate the priority levels of information such as mails from various behaviors of the user.

The behavior information about the user includes the data falling into the categories of viewing, communication, sorting, and priority levels. Accordingly, the priority levels of information such as mails can be estimated from various user behaviors falling into the categories of viewing, communication, sorting, and priority levels.

The category of viewing includes the data concerning the items of “viewing time”, “number of viewings”, and “attachment viewing”. The category of communication includes the data concerning the items of “responding” and “forwarding”. The category of sorting includes the data concerning the items of “deleting”, “deleting time”, “printing”, “saving”, and “place of saving”. The category of priority levels includes the data concerning the items of “viewing order” and “viewing time zone”. Accordingly, the priority level of information can be estimated from the items of “viewing time”, “number of viewings”, “attachment viewing”, “responding”, “forwarding”, “deleting”, “deleting time”, “printing”, “saving”, “place of saving”, “viewing order”, and “viewing time zone”.

Further, the sender information holding unit 13 holds the information about the senders of mails, the priority levels of the corresponding mails estimated by the priority estimating unit 12, and the mean priority level of the mails that is determined by the number of receptions of the mails corresponding to the sender information. If the information about the creator of information registered in the document server 16 is equal to the mail sender information stored in the sender information holding unit 13, and the mean priority level of the mails corresponding to the mail sender information is equal to or higher than a predetermined threshold value, the document recommending unit 15 presents the information registered in the document server 16 to the user. Accordingly, the information such as a document registered in the document server 16 can be recommended to the user in accordance with the value of the mean priority level of the mails. By the same technique as above, the document recommending unit 15 may present information such as a document registered in a memory (not shown) of the server 3 to the user.

In the above exemplary embodiment, the priority level of each mail is estimated. However, the information to be subjected to priority estimations is not limited to mails, but may be information in the form of documents, drawings, Web content, and the likes. In such cases, the priority level of a document, a drawing, or Web content can be estimated from various behaviors of the user.

In the above exemplary embodiment, the mail server 2, the server 3, and the document server 16 are independent of one another. However, the functions of the mail server 2 and the document server 16 may be incorporated into the server 3, and all the above-described procedures can be carried out in an information processing system including the server 3 and the client 1.

A recording medium on which the software program for realizing the functions of the server 3 is recorded is supplied to the server 3. The CPU of the server 3 reads and executes the program stored in the recording medium, and the same effects as those of the above-described exemplary embodiment can be achieved. The recording medium for supplying the program may be a CD-ROM, a DVD, or a SD card, for example.

The CPU of the server 3 may execute the software program for realizing the functions of the server 3, so as to achieve the same effects as those of the above-described exemplary embodiment.

It should be noted that the present invention is not limited to the above-described exemplary embodiment, and various changes and modifications may be made to it without departing from the scope of the invention.

What is claimed is:

1. An information processing device comprising:
a first acquiring unit that acquires user operation information with respect to information in a server, based on a history stored in the server;
a second acquiring unit that acquires a user operation history in a user terminal;
a first creating unit that creates user behavior information with respect to the information in the server, based on the user operation information acquired by the first acquiring unit and the user operation history acquired by the second acquiring unit;
a second creating unit that inquires of the user terminal for a priority level of sample information, and creates a probability table of priority levels of items included in the user behavior information; and
an estimating unit that estimates a priority level of the information in the server for the user, based on the user behavior information created by the first creating unit and the priority level probability table created by the second creating unit.

2. The information processing device according to claim 1, wherein the user behavior information includes data that fall into categories of viewing, communication, sorting, and priority levels.

3. The information processing device according to claim 2, wherein:
the category of viewing includes data concerning items of “viewing time”, “number of viewings”, and “attachment viewing”;
the category of communication includes data concerning items of “responding” and “forwarding”;
the category of sorting includes data concerning items of “deleting”, “deleting time”, “printing”, “saving”, and “place of saving”; and
the category of priority levels includes data concerning items of “viewing order” and “viewing time zone”.

4. The information processing device according to claim 1, wherein the information in the server is in the form of a document, a drawing, or Web content.

5. The information processing device according to claim 1, wherein the information in the server is a mail stored in the server, and the sample information is a mail received by the user terminal.

6. The information processing device according to claim 5, further comprising:
a holding unit that holds mail sender information, and a mean mail priority level of the sender information that is determined by the mail priority level estimated by the estimating unit with respect to the sender information and the number of mail receptions corresponding to the sender information; and
a document presenting unit that presents information registered in an external device or a memory to the user, when creator information about information stored in the memory is equal to the mail sender information stored in the holding unit, and the mean mail priority level corresponding to the mail sender information is equal to or higher than a predetermined threshold value.

7. The information processing device according to claim 6, further comprising
an updating unit that receives the mail priority level estimated by the estimating unit with respect to the sender information, and updates the mean mail priority level stored in the holding unit, based on the received mail priority level and the number of mail receptions corresponding to the sender information.

8. A computer readable recording medium causing a computer to execute a process for information processing, the process comprising:
acquiring user operation information with respect to information in a server, based on a history stored in the server;
acquiring a user operation history in a user terminal;
creating user behavior information with respect to the information in the server, based on the user operation information and the user operation history;
inquiring of the user terminal for a priority level of sample information, and creating a probability table of priority levels of items included in the user behavior information; and
estimating a priority level of the information in the server for the user, based on the user behavior information and the priority level probability table.

9. An information processing method comprising:
acquiring user operation information with respect to information in a server, based on a history stored in the server;
acquiring a user operation history in a user terminal;
creating user behavior information with respect to the information in the server, based on the user operation information and the user operation history;
inquiring of the user terminal for a priority level of sample information, and creating a probability table of priority levels of items included in the user behavior information; and
estimating a priority level of the information in the server for the user, based on the user behavior information and the priority level probability table.
